(19) United States
(12) Patent Application Publication
(10) Pub. No.: US 2006/0114220 A1
(43) Pub. Date: Jun. 1, 2006

(54) METHOD FOR CONTROLLING OPEPRATIONS OF A LIQUID CRYSTAL DISPLAY TO AVOID FLICKERING FRAMES

(76) Inventor: Shih-Chung Wang, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 10/904,250

(22) Filed: Nov. 1, 2004

(51) Int. Cl. G09G 3/36

(52) U.S. Cl. 345/103

(57) ABSTRACT

A method for controlling operations of liquid crystal display (LCD) is disclosed. The LCD has a plurality of display units, arranged in a plurality of rows. The display characteristics of the display units are changed every frame period according to received display data. The method involves dynamically changing a polarity operation mode of the LCD according to the display data of the display units in every frame period.

### BACKGROUND OF INVENTION

1. Field of the Invention

The invention relates to a method for controlling operations of a liquid crystal display, and more particularly, to a method that is capable of preventing flickering frames and achieving an improved picture quality.

2. Description of the Prior Art

A liquid crystal display (LCD) has advantages of being light weight, having low power consumption, and having low divergence and is applied to various portable electronic products such as notebook computers and personal digital assistants (PDAs). In addition, LCD monitors and LCD televisions are gaining in popularity as a substitute for traditional cathode ray tube (CRT) monitors and televisions. Under different arrangements, the liquid crystal molecules are able to produce different polarizing and refractive effects toward a light source and control the amount of light penetration for generating an output light with different intensities. By utilizing the characteristics of the liquid crystal molecules, the LCDs are able to generate red, blue, and green lights with different gray intensities and further produce colorful images.

Please refer to FIG. 1. FIG. 1 is a perspective diagram showing the thin film transistor (TFT) liquid crystal display (LCD) 10 of the prior art. The LCD 10 includes a LCD panel 12, a control circuit 14, a source driver 16, a gate driver 18, a first voltage generator 20, and a second voltage generator 22. The LCD panel 12 is comprised of two substrates, in which the center of the two substrates is filled with liquid crystal materials. One of the substrates includes a plurality of data lines 24 positioned on top of the substrate, a plurality of scan lines 26 perpendicular to the data lines 24, and a plurality of thin film transistors 28, whereas the other substrate includes a common electrode positioned on the substrate for providing a fixed voltage Vcom via the first voltage generator 20. For illustration purposes, only four thin film transistors 28 are shown in FIG. 1. In reality, each joint section of the data line 24 and the scan line 26 is connected to a thin film transistor 28. Hence the thin film transistor 28 is distributed on the LCD panel 12 in a matrix form, in which each data line 24 corresponds to each column of the TFT LCD 10, each scan line 26 corresponds to each row of the TFT LCD 10, and each thin film transistor 28 corresponds to each of the display units. In a color LCD, each pixel includes three or four of the display units discussed previously. In addition, the circuit property of the two substrates comprising the LCD panel 12 can be treated as an equivalent capacitor 30.

The fundamental driving principle of the TFT LCD 10 is as follows: when the control circuit 14 receives a horizontal synchronizing signal 32 and a vertical synchronizing signal 34, the control circuit 14 will input a corresponding control signal to the source driver 16 and the gate driver 18. By generating input signals to different data lines 24 and scan lines 26 according to the control signal, the source driver 16 and the gate driver 18 are able to turn the thin film transistor 28 on and off and control the electrical potential difference between the two ends of the equivalent capacitor 30, and further alter the arrangement of the liquid crystal molecules and the amount of corresponding light penetration. For instance, after the thin film transistor 28 is turned on by inputting a pulse from the gate driver 18 to the scan lines 26, the data line 24 signals input by the source driver 16 can be transmitted to the equivalent capacitor 30 via the thin film transistor 28 for controlling the gray level of the corresponding pixels. Also, the size of the data line 24 signals input by the source driver 16 are controlled by an electrical voltage generator 22, and as a result, different voltage levels correspond to different gray levels.

If a positive voltage is continuously used for driving the liquid crystal molecules, the polarizing and refractive effect of the liquid crystal molecules toward light beams will decrease and result in degradation of the picture quality. Similarly, a decrease in picture quality will also result if a negative voltage is continuously used for driving the liquid crystal molecules. Hence, positive and negative voltages need to be utilized interchangeably in order to protect the display quality of the liquid crystal molecules from damage caused by the driving voltages. Please refer to FIG. 2 to FIG. 7. FIG. 2 and FIG. 3 are perspective diagrams showing the one line inversion of the prior art, FIG. 4 and FIG. 5 are perspective diagrams showing the two line inversion of the prior art, and FIG. 6 and FIG. 7 are perspective diagrams showing the column inversion of the prior art. In order to reduce the influence to the output frames by driving the liquid crystal molecules via the method of utilizing positive and negative voltage interchangeably, methods such as the one line inversion, the two line inversion, and the column inversion are often utilized for improving the flickering frame phenomenon. As shown in FIG. 2 to FIG. 7, the first frame 42 and the second frame 44 are two consecutive frames in which the polarity of the display unit 46 in the first frame 42 is the opposite of the polarity of the display unit 79 in the second frame 44. In addition, the polarity arrangement of the display units 46 is also subdivided into one line inversion, two line inversion, and column inversion. In contrast to two line inversion and column inversion, the one line inversion is capable of providing a much better frame quality. Nevertheless, a flickering phenomenon often occurs during the play of repetitive frames when the one line inversion mode is utilized.

### SUMMARY OF INVENTION

It is therefore an objective of the present invention to provide a method that is capable of actively switching the LCD operational mode for solving the problems stated previously.

The method of the present invention is utilized for controlling operations of a liquid crystal display (LCD), in which the LCD includes a plurality of display units arranged in a plurality of rows and changes the display characteristics of the display units every other frame period according to the received display data. The method includes the following steps: (a) dividing each row of the display units into a plurality of groups, in which each group includes a plurality of the display units; (b) classifying the display units of each group into the first category display units and the second category display units, in which the number of the first category display units is equal to the number of the second category display units; (c) comparing the display data of the first category display units and the second category display units at each frame period for determining the characteristics of each group at each frame period; (d) determining the characteristics of the rows at each frame period according to the characteristics of the groups at each frame period; (e) determining the characteristics of the display at each frame period according to the characteristics of the rows at each frame period; and (f) actively switching the operation mode of the liquid crystal display according to the characteristics of the display at each frame period.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective diagram showing the thin film transistor liquid crystal display of the prior art.

FIG. 2 and FIG. 3 are perspective diagrams showing the one line inversion of the prior art.

FIG. 4 and FIG. 5 are perspective diagrams showing the two line inversion of the prior art.

FIG. 6 and FIG. 7 are perspective diagrams showing the column inversion of the prior art.

FIG. 8 to FIG. 11 are perspective diagrams showing the means by which each display unit of the liquid crystal display is divided into the first category display units and the second category display units according to the present invention.

FIG. 12 to FIG. 14 are flowchart diagrams showing the method of the present invention.

### DETAILED DESCRIPTION

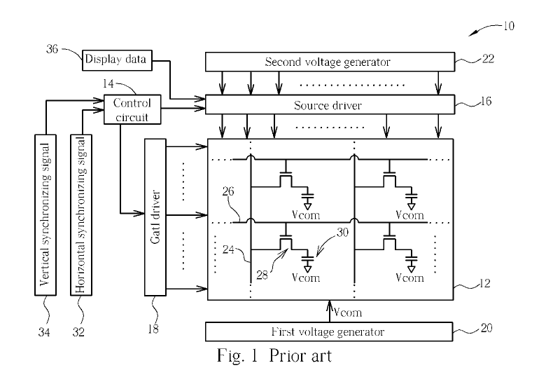

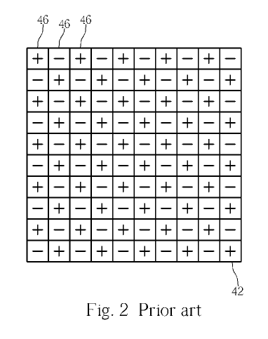

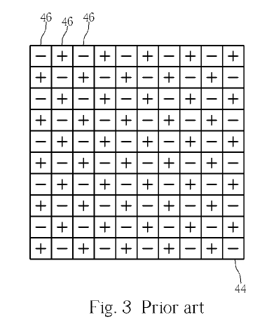

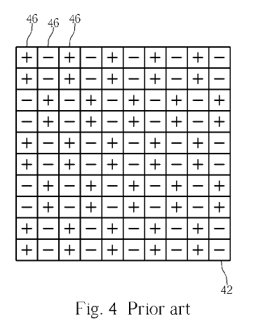

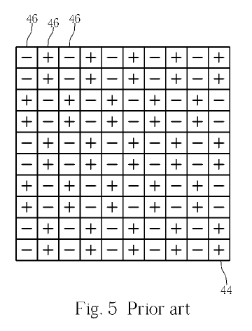

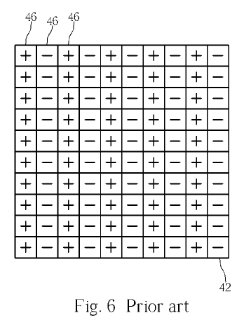

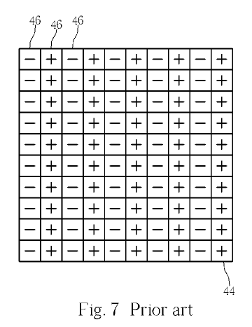

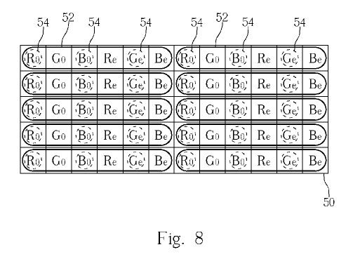

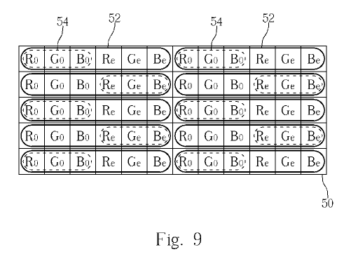

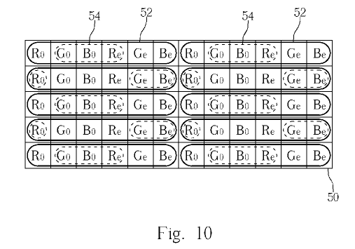

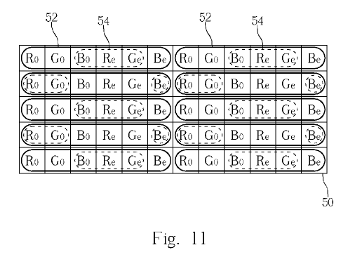

Due to the fact that the LCD hardware architecture of the present invention is very similar to the LCD 10 from FIG. 1, only the driving method will be discussed in this section. Please refer to FIG. 8. FIG. 8 is a perspective diagram showing the means by which each display unit of the liquid crystal display is divided into different groups according to the present invention. The LCD 50 includes a plurality of display units Ro, Go, Bo, Re, Ge, and Be arranged in a plurality of rows. Each of the display units is utilized for showing the corresponding gray level of three, in which a pixel is essentially comprised of every three display units of Ro, Go, Bo, or Re, Ge, Be. Despite the fact that only 20 pixels are included in FIG. 8, the LCD 50 in real life will include much more pixels. According to the present invention, each of the display units Ro, Go, Bo, or Re, Ge, Be of the LCD 50 is divided into a plurality of groups 52, in which each of the groups 52 will include two pixels (hence a total of six display units). Next, each display unit of the plurality of groups 52 will be further divided into sub-categories such as the first category display units and the second category display units according the various detective methods. As shown in FIG. 8, the display units Ro, Bo, Ge circled by a dotted line 54 in the odd number row are the first category display units and the display units Go, Re, Be not circled by the dotted line 54 are the second category display units. In the even number row, the display units Go, Re, Be circled by the dotted line 54 are the first category display units and the display units Ro, Bo, Ge not circled by the dotted line 54 are the second category display units. Please refer to FIG. 9 to FIG. 11. FIG. 9, FIG. 10, and FIG. 11 are diagrams showing three different categorization methods of the display units. As shown in the figures, the group 52 is circled by a solid line, in which the displays units circled by the dotted line 54 are the first category display units and the ones not circled by the dotted line 54 are the second category display units. As shown in FIG. 9, the first category display units include the display units Ro, Go, Bo from the odd number row and the display units Re, Ge, Be from the even number row whereas the second category display units include the display units Re, Ge, Be from the odd number row and the display units Ro, Go, Bo from the even number row. However, it should be noted that the categorization of the first category display units and the second category display units is not limited to the methods listed above. In addition, despite the fact that the present invention utilizes display units containing pixels with three different colors of red, blue, and green, other display units that contain pixels with four different colors are also applicable to the present invention.

After the display units are divided into a plurality of groups 52, the polarity of each group 52 will be determined periodically and utilized later by the LCD 50 for switching the polarity operation mode. The polarity of each group 52 at each frame period is determined by the corresponding gray level of the display data. If one of the group 52 results obtained from subtracting the corresponding gray level of the display data of the second category display units from the corresponding gray level of the display data of the first category display units is greater than the predetermined value FL_THR, and all of the results obtained from subtracting the corresponding gray level of the display data of the first category display units from the corresponding gray level of the display data of the second category display units is not greater than the threshold value FL_DIF, the group is defined as a positive group. Conversely, if all of the results obtained from subtracting the corresponding gray level of the display data of the second category display units from the corresponding gray level of the display data of the first category display units is not greater than the threshold value FL_DIF, and one of the results obtained from subtracting the corresponding gray level of the display data of the first category display units from the corresponding gray level of the display data of the second category display units is greater than the predetermined value FL_THR, the group is defined as a negative group. As shown in FIG. 8, which utilizes odd number rows as an example, the various methods for determining the positive group or the negative group stated previously can be represented by the equations below:

Positive: (Ro−Go>FL_THR|Bo−Re>FL_THR|Ge−Be>FL_THR) & (Go−Ro>FL_DIF|Re−Bo>FL_DIF|Be−Ge>FL_DIF)

Negative: (Ro−Go>FL_DIF|Bo−Re>FL_DIF|Ge−Be>FL_DIF) & (Go−Ro>FL_THR|Re−Bo>FL_THR|Be−Ge>FL_THR)

According to the equations shown above, Ro, Go, Bo, Re, Ge, and Be are display units and Ro, Go, Bo, Re, Ge, and Be are gray levels of the frame period. Similarly, the determination equation of the odd number row of FIG. 9 can be represented by the formulae below:

Positive: (Ro−Re>FL_THR|Go−Ge>FL_THR|Bo−Be>FL_THR) & ˜(Re−Ro>FL_DIF|Ge−Go>FL_DIF|Be−Bo>FL_DIF)

Negative: ˜(Ro−Re>FL_DIF|Go−Ge>FL_DIF|Bo−Be>FL_DIF) & (Re−Ro>FL_THR|Ge−Go>FL_THR|Be−Bo>FL_THR)

The determined equation of the odd number row of FIG. 10 can be represented by the formulae below:

Positive: (Re−Ro>FL_THR|Go−Ge>FL_THR|Bo−Be>FL_THR) & ˜(Ro−Re>FL_DIF|Ge−Go>FL_DIF|Be−Bo>FL_DIF)

Negative: ˜(Re−Ro>FL_DIF|Go−Ge>FL_DIF|Bo−Be>FL_DIF) & (Ro−Re>FL_THR|Ge−Go>FL_THR|Be−Bo>FL_THR)

The determined equation of the odd number row of FIG. 11 can be represented by the formulae below:

Positive: (Re−Ro>FL_THR|Ge−Go>FL_THR|Bo−Be>FL_THR) & ˜(Ro−Re>FL_DIF|Go−Ge>FL_DIF|Be−Bo>FL_DIF)

Negative: ˜(Re−Ro>FL_DIF|Ge−Go>FL_DIF|Bo−Be>FL_DIF) & (Ro−Re>FL_THR|Go−Ge>FL_THR|Be−Bo>FL_THR)

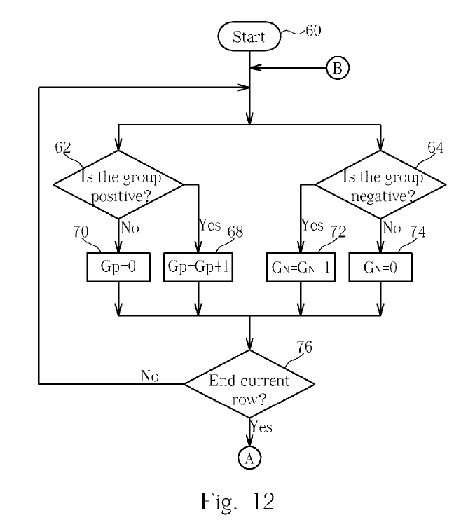

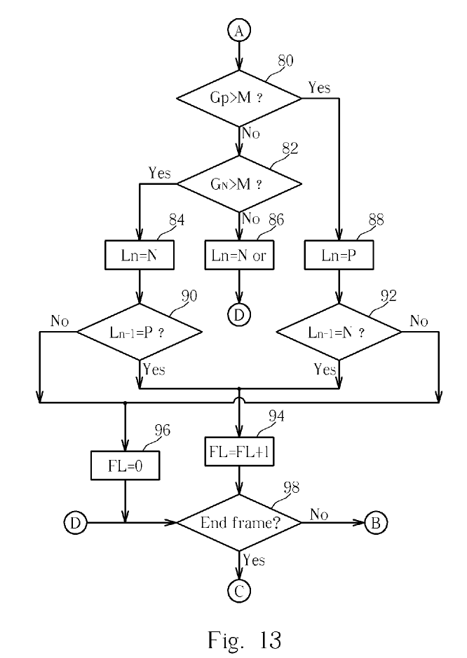

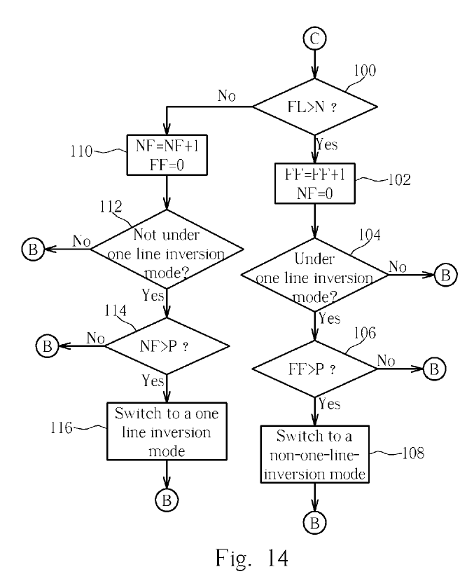

Please refer to FIG. 12 to FIG. 14. FIG. 12 to FIG. 14 are flow chart diagrams of the present invention. After the LCD is activated (step 60), the timing for switching the polarity operation mode of the LCD is determined according to the steps shown in FIG. 12 to FIG. 14. First, the polarity of each group is determined according to the method stated above to be a positive group (step 62) or a negative group (step 64). If the determination of a positive group is true, the accumulated positive group number G_{P} will increase by one (step 68) whereas if the determination of the positive group is false, the accumulated positive group number G_{P} will return to zero (step 70). Conversely, if the determination of a negative group is true, the accumulated negative group number G_{N} will increase by one (step 72) whereas if the determination of the negative group is false, the accumulated negative group number G_{N} will return to zero (step 74). When the polarity of the group is determined, the determined group will be further decided upon whether the group is the last group of the display unit row (step 76). If the determined group is not the last group, the next group in the same row will be determined and if the determined group is confirmed to be the last group, the next step will be performed. By following steps 62 to 76, the continuous positive group number G_{P} and the continuous negative group number G_{N} of each group of the one line display units will be obtained.

After the polarity of each row group is determined, steps 80 and 82 are performed to determine whether the accumulated positive group number G_{P} or the negative group number G_{N} is greater than a whole number M. If both G_{P} and G_{N} are not greater than M, the current row Lₙ is defined as a normal row (step 86) with the expression Lₙ=Nor (Normal), in which n indicates the position of the current row and step 98 will be performed next. If the positive group number G_{P} is greater than M, the current row Lₙ is defined as a positive row (step 88) with the expression Lₙ=P (Positive). If the negative group number G_{N} is greater than M, the current row Lₙ is defined as a negative row (step 84) with the expression Lₙ=N (Negative) and the previous row Lₙ₋₁ is then determined to be a positive row or not (step 90). If the previous row Lₙ₋₁ is a positive row, the current row Lₙ is defined as a flickering row and the continuous flickering line FL will be incremented by one (step 94). If the previous row Lₙ₋₁ is not a positive row, the continuous flickering line FL will be returned to zero.

Similarly, after step 88 is performed, the previous row Lₙ₋₁ is determined to be a negative row or not and if the previous row Lₙ₋₁ is a negative row, the current row Lₙ is defined as a flickering row and the continuous flickering line FL will be incremented by one (step 94). However, if the previous row Lₙ₋₁ is not a negative row, the continuous flickering line FL will be returned to zero (step 96). After the determination of a flickering row is completed, the current row Lₙ will be determined to be a last row or not (step 98). If the current row Lₙ is not the last row, steps 62 and 64 will be performed. However if the current row Lₙ is the last row, the next step will be performed. By going through steps 80 to 98, the number of continuous flickering lines FL included by the frame within a single display period can be calculated.

After the continuous flickering line FL included in each frame is calculated, the continuous flickering line FL of the display period is determined to be larger than a whole number N or not (step 100). If the determination is true, the number of continuous flickering frames FF will be incremented by one and the number of continuous normal frames NF will be returned to zero, as shown in step 102. Conversely, if the determination is false, the number of continuous normal frames NF will be incremented by one and the number of continuous flickering frames FF will be returned to zero, as shown in step 110. After step 102 is completed, the polarity operation mode of the LCD is determined to be a one line inversion mode or not (step 104). If the determination result is false, steps 62 and 64 will be performed and if the result is true, step 106 will be performed for determining whether the continuous flickering frame EF is larger than a whole number P and if the determination after step 106 is false, steps 62 and 64 will be performed. If the determination is true, it indicates that under the one line inversion driving mode, as many as P+1 frames of continuous frame periods are flickering frames and after a period of time, the polarity operation mode of the LCD will be switched from the one line inversion mode to the non-one-line-inversion mode (step 108) and steps 62 and 64 will be performed next. In general, the non-one-line-inversion driving mode refers to any other driving modes that are not related to the one line inversion driving mode. After step 110 is completed, the polarity operation mode of the LCD is determined to be not under the one line inversion driving mode (step 112) and if the result is false, steps 62 and 64 will be performed. If the result is true, step 114 is performed for determining whether the number of continuous normal frames NF is larger than the whole number P. If step 114 is determined to be false, steps 62 and 64 will be performed next and if step 114 is determined to be true, it indicates that the polarity operation mode of the LCD is not under the one line inversion driving mode and as many as P+1 frames of continuous frame periods are normal frames and after a period of time, the polarity operation mode of the LCD will be switched from the non-one-line-inversion mode to the one line inversion mode (step 116) and steps 62 and 64 will be performed next.

It should be noted that the determination process discussed previously can be conducted in many ways simultaneously according to different categorization methods. As an example of a group categorization method shown in FIGS. 8 to 11, four processes are being conducted separately at the same time. If one of the four processes determines that the polarity operation mode of the LCD is to be switched, the process will then give an order to the LCD to switch to a different operation mode.

By utilizing the determination method stated previously, the possibility of a flickering frame phenomenon appearing while the LCD is operated under the one line inversion mode can be determined instantly. If a flickering frame is predicted to appear, the polarity operation mode of the LCD is switched from the one line inversion mode to a non-one-line inversion mode for preventing the flickering frame. If a non-flickering frame is predicted to appear after the LCD is switched to the non-one-line inversion mode, the polarity operation mode of the LCD is switched back to the one line inversion mode again. Hence, the LCD is operated under the one line inversion mode during normal conditions for producing a much better picture quality when the flickering frame is not appearing. However, when the flickering frame appears, the LCD will be switched to a non-one-line inversion mode to prevent the flickering phenomenon.

In contrast to the polarity operation method of the prior art LCD, the present invention is capable of actively switching the polarity operation method of the LCD according to the display data and thereby producing a much better frame quality. In order to prevent a flickering frame phenomenon, the method enables users to switch to a non-one-line-inversion driving mode when a repetitive frame takes place.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling the operations of a liquid crystal display (LCD), wherein the liquid crystal display includes a plurality of display units arranged in a plurality of rows and changes the display characteristics of the display units every other frame period according to received display data, the method comprising:
(a) dividing each row of the display units into a plurality of groups, in which each group includes a plurality of the display units;
(b) classifying the display units of each group into the first category display units and the second category display units, in which the number of the first category display units is equal to the number of the second category display units;
(c) comparing the display data of the first category display units and the second category display units at each frame period for determining the characteristics of each group at each frame period;
(d) determining the characteristics of the rows at each frame period according to the characteristics of the groups at each frame period;
(e) determining the characteristics of the display at each frame period according to the characteristics of the rows at each frame period; and
(f) actively switching a polarity operation mode of the liquid crystal display according to the characteristics of the display at each frame period.

2. The method of claim 1 further comprising:
(g) repeating step (b) and selecting a different combination of display units as the first category display units and the second display units while dividing the display units into categories; and
(h) performing steps (c), (d), (e), and (f) according to the first category display units and the second category display units chosen from step (g).

3. The method of claim 1 wherein step (c) includes the following steps:
if one of results obtained from subtracting corresponding gray levels of the display data of the second category display units from corresponding gray levels of the display data of the first category display units is greater than a predetermined value, and none of results obtained from subtracting the corresponding gray levels of the display data of the first category display units from the corresponding gray levels of the display data of the second category display units is greater than a threshold value, defining the group as a positive group; and
if none of the results obtained from subtracting the corresponding gray levels of the display data of the second category display units from the corresponding gray levels of the display data of the first category display units is greater than the threshold value, and one of the results obtained from subtracting the corresponding gray levels of the display data of the first category display units from the corresponding gray level of the display data of the second category display units is greater than the predetermined value, defining the group as a negative group.

4. The method of claim 3 wherein step (d) includes the following steps:
if a number of continuous positive groups of one of the rows is greater than an integer M, defining the row as a positive row; and
if a number of continuous negative groups of one of the rows is greater than the integer M, defining the row as a negative row.

5. The method of claim 4 wherein step (e) includes the following step:
if N (N being a whole positive number) continuous rows in a frame are defined as either positive rows or negative rows, and each of the positive rows of the N continuous rows is adjacent to at least one of the negative rows of the N continuous rows, defining the frame as a flickering frame, otherwise defining the frame as a normal frame.

6. The method of claim 5 wherein step (f) includes the following steps:
if P (P being a whole positive number) continuous frames are all flickering frames and the polarity operation mode of the LCD is a one line inversion mode, switching the polarity operation mode of the LCD to a different mode; and
if P continuous frames are all normal frames and the polarity operation mode of the LCD is not the one line inversion mode, switching the polarity operation mode of the LCD to the one line inversion mode.

7. The method of claim 1 wherein each group includes two pixels and each pixel includes three of the display units.

8. The method of claim 1 wherein each group includes two pixels and each pixel includes four of the display units.
